(19) United States
(12) Patent Application Publication
(10) Pub. No.: US 2008/0061929 A1
(43) Pub. Date: Mar. 13, 2008

(54) Method and system for transmit scheduling and dynamic strength adjustment of a security fob signal

(76) Inventors: Daryl C. Cromer, Apex, NC (US); Sulai Hung, Cary, NC (US); Matthew R. Jones, Raleigh, NC (US); James S. Rutledge, Durham, NC (US); Aaron Stewart, Raleigh, NC (US); Sean M. Ulrich, Morrisville, NC (US)

Correspondence Address: LENOVO (UNITED STATES) INC.;c/o Sawyer Law Group LLP, P.O. BOX 51418, PALO ALTO, CA, 94303, US

(21) Appl. No.: 11/496,253

(22) Filed: Jul. 31, 2006

(51) Int. Cl. G05B 19/00

(52) U.S. Cl. 340/5.61; 340/5.62; 340/5.63; 340/5.72; 340/426.13; 307/10.5; 713/185

(57) ABSTRACT

Methods and systems for managing communication between a key fob and a host device are provided. In one implementation, the system includes a key fob configured to operate in accordance with one of a plurality of modes, including an automatic mode and a manual mode. The system further includes a host device associated with the key fob, wherein responsive to the key fob operating in accordance with the automatic mode, the key fob is configured to page periodically, and the host device is configured to page-scan periodically to detect a page from the key fob. In one implementation, the key fob further includes a controller configured to dynamically adjust a signal strength of a communication signal between the key fob and the host device in accordance with a mode of operation selected (or desired) by the user.

### FIELD OF THE INVENTION

The present invention relates generally to digital communications, and more particularly to digital communications between a fob and a host device.

### BACKGROUND OF THE INVENTION

Electronic key fobs are typically used for remote keyless systems on motor vehicles. Early electric key fobs operated using infrared and, therefore, needed a clear line of sight, and could be copied using a programmable remote control. More recent models use challenge-response authentication over radio frequency (RF), so these are harder to copy and do not need line of sight to operate. One example of an electronic key fob is a Bluetooth™ key fob. The Bluetooth key fob is a portable device designed to work much like an automotive key fob, however, to arm and disarm, for example, a user's laptop computer (or other device). Bluetooth wireless technology is a short-range radio frequency (RF) technology that makes it possible to transmit signals over short distances between, e.g., key fobs, computers and other devices and thereby simplify communication and synchronization between devices.

With respect to an example in which a Bluetooth key fob (referred to herein as “key fob”) is used to arm and disarm a user's laptop, the laptop is typically equipped with a theft deterrent system that includes a motion detector. Accordingly, if the theft deterrent system is armed and motion (of the laptop) is detected, then the theft deterrent system can, for example, activate an audible alarm and/or disable the laptop computer. A key fob typically operates in accordance with one of two modes—a manual mode and an automatic mode. In the manual mode, a user can arm and disarm a laptop by pressing a manual button. In the automatic mode, the theft deterrent system automatically arms the laptop when the key fob is out of communication range with the laptop, and automatically disarms the laptop when the key fob is within communication range of the laptop. According to conventional automatic modes of operation, either the key fob or the laptop computer page-scans continuously while the other device pages periodically. The continuous operation (e.g., page-scanning) performed by the key fob or the laptop computer, however, requires a large (heavy) battery to be used in either the key fob or the laptop computer, which burdens ease of use of the portable devices.

In addition, with respect to the both the manual mode and the automatic modes of operation, the effective range of the key fob is generally governed by the power of the (Bluetooth) signal. For example, Bluetooth class 2 communication permits an effective (communication) range of approximately 30 meters. In the manual mode of operation, having a 30 meter communication range is desirable to ensure that a user can activate a state change of the laptop computer (e.g., arm/disarm). However, use of such a long communication range in the automatic mode can create potential security risks as a user may not be able to see or hear a laptop that is 30 meters away, and yet because the key fob is still within communication range of the laptop, the theft deterrent system will be disarmed.

Accordingly, what is needed is a system and method for improved communication techniques between a key fob and a host device (e.g., a laptop or other device). The present invention addresses such a need.

### BRIEF SUMMARY OF THE INVENTION

In general, in one aspect, this specification describes a system including a key fob configured to operate in accordance with one of a plurality of modes, including an automatic mode and a manual mode. The system further includes a host device associated with the key fob, in which responsive to the key fob operating in accordance with the automatic mode, the key fob is configured to page periodically and the host device is configured to page-scan periodically to detect a page from the key fob.

Implementations can include one or more of the following features. The key fob can include a mode selector configured to provide a user with an ability to select a mode of operation for the key fob. The mode selector can comprise one or more of a switch, a button, or a display screen. The key fob can further include a controller configured to dynamically adjust a signal strength of a communication signal between the key fob and the host device in accordance with a mode of operation selected by the user. The controller can be configured to increase the signal strength of the communication signal in response to the user selecting the manual mode of operation, and decrease the signal strength of the communication signal in response to the user selecting the automatic mode of operation. The plurality of modes of operation associated with the key fob can not be exclusive of one another. The user can select the manual mode of operation by pressing a manual button on the key fob at any time regardless of a current operation mode of the key fob. In response to the host device detecting a page from the key fob, the host device can perform a first function. In response to the host device not detecting a page from the key fob, the host device can perform a second function. The host device can include a theft deterrent system. The first function can comprise disarming the theft deterrent system associated with the host device. The second function can comprise arming the theft deterrent system associated with the host device. The host device can comprise at least one of a workstation, a desktop computer, a laptop computer, a personal digital assistant (PDA), a cell phone, a network, a bicycle, an automobile, or other device having a function that is controllable by the key fob.

In general, in another aspect, this specification describes a system including a first device configured to operate in accordance with an automatic mode, and a second device associated with the first device. Responsive to the first device operating in accordance with the automatic mode, the first device is configured to page periodically, and the second device is configured to page-scan periodically to detect a page from the first device.

In general, in another aspect, this specification describes a computer-implemented method including receiving user input selecting a mode of operation for a key fob, and dynamically adjusting a signal strength of the key fob in accordance with the mode of operation selected by the user.

Implementations may provide one or more of the following advantages. In one implementation, a transmission schedule between a key fob and host device is provided that extends the battery life of each device relative to conventional techniques of communication. The transmission schedule further provides more bandwidth for the operation of devices other than a key fob with the host device. In addition, in one implementation, the signal strength of the key fob is automatically configured by software based on whether the key fob is operating in an automatic mode or a manual mode. Such an automatic configuration of signal strength provides for greater security of the host device when the key fob is operating in the automatic mode (e.g., by the software reducing the signal strength), and also provides for greater user control when the key fob is operating in the manual mode (e.g., by the software increasing the signal strength). In one implementation, the automatic and manual modes of operation of the key fob are not exclusive. For example, in one implementation, while a key fob is operating in an automatic mode, a user can at any time arm/disarm (e.g.) a laptop by pressing a manual arm/disarm button.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of a system including a key fob and a host device in accordance with one implementation of the invention.

FIG. 2 illustrates a method of communication between a key fob and a host device in accordance with one implementation of the invention.

FIG. 3 illustrates a method for adjusting the signal strength of a key fob in accordance with one implementation of the invention.

FIG. 4 is a block diagram of a key fob and host devices in accordance with one implementation of the invention.

Like reference symbols in the various drawings indicate like elements.

### DETAILED DESCRIPTION OF THE INVENTION

Implementations of the present invention relates generally to digital communications, and more particularly to digital communications between a fob and a host device. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

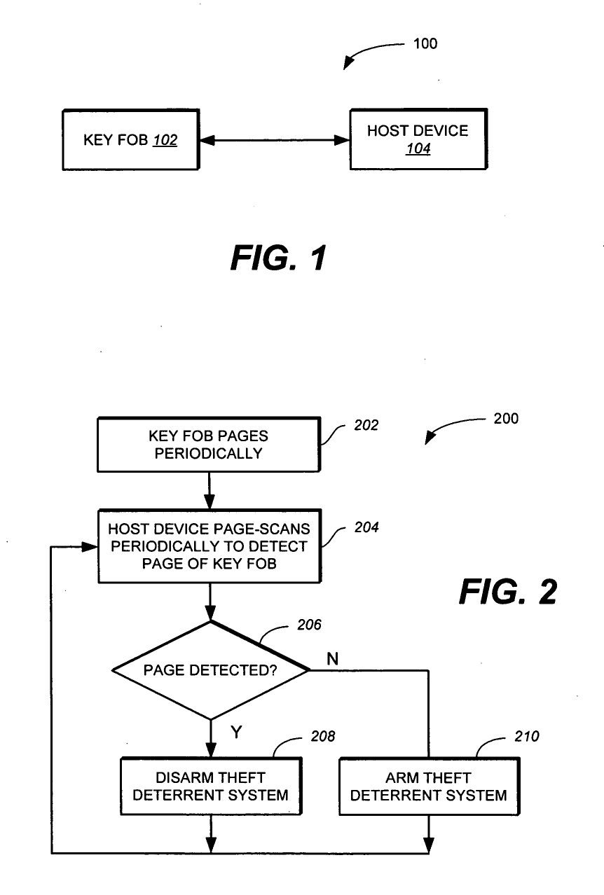

FIG. 1 illustrates a system 100 including a key fob 102 and a host device 104 in accordance with one implementation of the invention. Although the system 100 is shown as including one key fob and one host device, the system 100 can include any number of key fobs and host devices. In general, a user uses the key fob 102 to control one or more functions associated with the host device 104. In one implementation, a user uses the key fob 102 to arm/disarm a theft deterrent system associated with the host device 104, as discussed in greater detail below. In one implementation, the key fob 102 communicates with the host device 104 using wireless technology (e.g., Bluetooth wireless technology). In general, the key fob 102 can communicate with the host device 104 using any radio frequency (RF) technology, including (for example) infrared, Wi-Fi (wireless fidelity), and the like. The host device 104 can be any type of device or object including for example, a workstation, a desktop computer, a laptop computer, a personal digital assistant (PDA), a cell phone, a network, a bicycle, an automobile, or other device (or object) having a function that is controllable by a key fob. In one implementation, the key fob 102 further includes software for dynamically adjusting a signal strength of a communication signal between the key fob 102 and the host device 104 based on a mode of operation of the key fob 102, as discussed in greater detail below.

FIG. 2 illustrates a method 200 of communication between a key fob (e.g., key fob 102) and a host device (e.g., host device 104) in accordance with one implementation. In the implementation shown in FIG. 2, the key fob is operating in accordance with an automatic mode of operation to control a function associated with the host device—e.g., to arm/disarm a theft deterrent system associated with the host device. More generally, functions other than arming/disarming a theft deterrent system can also be performed including, for example, turning on/off the host device, locking/unlocking the host device, waking/putting the host device to sleep, and so on. Although FIG. 2 is described with the key fob operating in an automatic mode of operation, (in one implementation) such a mode of operation is not exclusive of other modes of operation—e.g., a manual mode of operation. For example, in one implementation, while a key fob is operating in an automatic mode, a user can at any time arm/disarm a corresponding host device by pressing a manual arm/disarm button.

The key fob pages periodically (step 202). The host device page-scans periodically to detect a page of the key fob (step 204). Thus, unlike a conventional automatic mode of communication between a key fob and a host device in which one device page-scans continuously, the host device of the present invention only page-scans periodically to conserve power and, therefore, extend the battery life of a battery within the host device (if applicable). A determination is made by the host device whether a page from the key fob has been detected (step 206). If a page from the key fob is detected, then the theft deterrent system associated with the host device is disarmed (if previously armed) or remains unarmed (step 208). If, however, a page from the key fob is not detected, then the theft deterrent system is armed (step 210). After steps 208, 210, the method 200 returns to step 204, in which the host device again page-scans to detect a page from the key fob.

Accordingly, in one implementation, a communication schedule is provided below in which both the key fob and the host device are respectively paging and page-scanning periodically, e.g., to conserve power. The communication schedule provided below is an example communication schedule that is applicable to Bluetooth wireless technology. Other communication schedules can be implemented for the Bluetooth wireless technology and other RF technologies that are consistent with the principles discussed herein. In one implementation, the host device page-scans at a rate substantially within the range of −20 ms every 1.28 seconds to 20 ms every 100 ms. Increasing the page-scan rate decreases generally decreases a response time of the host device (or the device performing the page-scanning). In an implementation, in which the host device is page-scanning for 20 ms every 100 ms, such a rate still provides a relatively large bandwidth—e.g., 80% bandwidth—for (Bluetooth) wireless communication of devices (other than the key fob) with the host device. In one implementation, when in range (in the automatic mode), the key fob enters into a sniff mode and sniffs (or pages) for 3.125 ms every 250 ms. Thus, assuming a radio current of 44 mA, a baseband-only current of 20 mA, and a sleep current of 0.07 mA, a key fob would only require a 220 mAh battery to operate in range for 1 month (ignoring loss in other circuits, LEDs, and so on). To further conserve battery life, the key fob can reduce its communication frequency when out of range of a corresponding host device. For example, (in one implementation) the key fob pages at a rate of 20 ms every 2.56 seconds when out of range of the corresponding host device. Such a communication schedule is summarized in Table 1 below.

TABLE 1

| | Key Fob Out of Range |
|---|---|
| Key Fob In Range of Host Device | of Host Device |
| 250 ms sniff interval | 20 ms sniff interval |
| 3.125 ms sniff window | 2.56 seconds sniff window |
| 44 mA radio current | 44 mA active current |
| 20 mA baseband-only current | 0.07 mA sleep current |
| 0.07 mA sleep current | |
| 0.439125 mA average | 0.413203 mA average |
| 220 mAh battery capacity | 220 mAh battery capacity |
| 500.9963 hours | 532.4258 hours |
| 20.87485 days | 22.18441 days |

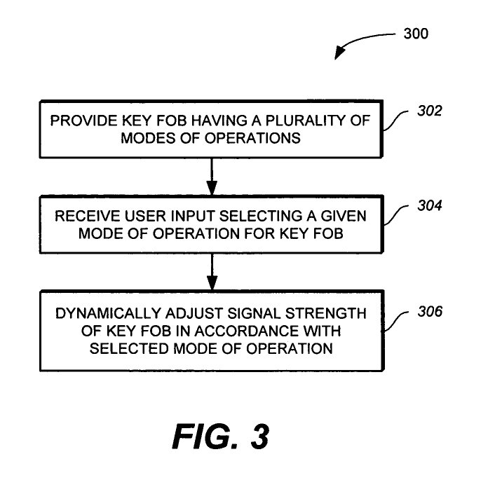

FIG. 3 illustrates a method 300 for adjusting the signal strength of a key fob (e.g., key fob 102) in accordance with one implementation of the invention. A key fob is provided having a plurality of modes of operations (step 302). In one implementation, a key fob is provided having a manual mode of operation and an automatic mode of operation. In the manual mode of operation, a user is operable to manually control a function associated with a corresponding host device (e.g., host device 104) by, e.g., pressing a button on the key fob. In the automatic mode of operation, the key fob is operable to automatically activate a function associated with a corresponding host device without user intervention. In one implementation, in the automatic mode, the key fob automatically activates a function associated with a corresponding host device dependent upon whether the key fob is in range (or out of range) of the host device. Other schemes for automatic activation of functions associated with a host device can also be implemented. In one implementation, the operation modes of the key fob are not exclusive of one another. For example, (in one implementation), as discussed above, while a key fob is operating in an automatic mode, a user can at any time arm/disarm a corresponding host device by pressing a manual arm/disarm button. In this implementation, the key fob can have a switch (or button) that turns on/off an automatic mode of operation for the key fob.

Referring to FIG. 3, user input selecting a given mode of operation for the key fob is received from the user (step 304). In one implementation, the user selects a mode of operation for the key fob by pressing a button (or switch), or by selecting a menu item in a display screen of the key fob. In one implementation, the key fob can be toggled between an automatic mode or a manual mode of operation. In another implementation, the key fob can be toggled between an automatic mode-on or automatic mode-off, in which case a manual mode of operation is available (e.g., by the user pressing a manual button on the key fob) regardless of whether the automatic mode is enabled. The (communication) signal strength of the key fob is (automatically) dynamically adjusted in accordance with the mode of operation selected (or desired) by the user (step 306). Thus for example, in one implementation, when a user selects a manual mode of operation (or when a manual arm/disarm button is pressed while the key fob operating in an automatic mode of operation), the signal strength of the key fob is increased to permit the user to have maximum control over the host device from a relatively large distance (e.g., 30 meters or more). In like manner, when the user selects an automatic mode of operation, the signal strength of the key fob is reduced so that, e.g., a theft deterrent system of the host device can be activated when the user is a relatively shorter distance from the host device. In one implementation, the signal strength of the key fob can be adjusted in real-time by a user. In one implementation, the signal strength of the key fob is adjustable through a software application running on the host device. In this implementation, the software program can, for example, throttle the radio frequency (RF) range of the host device.

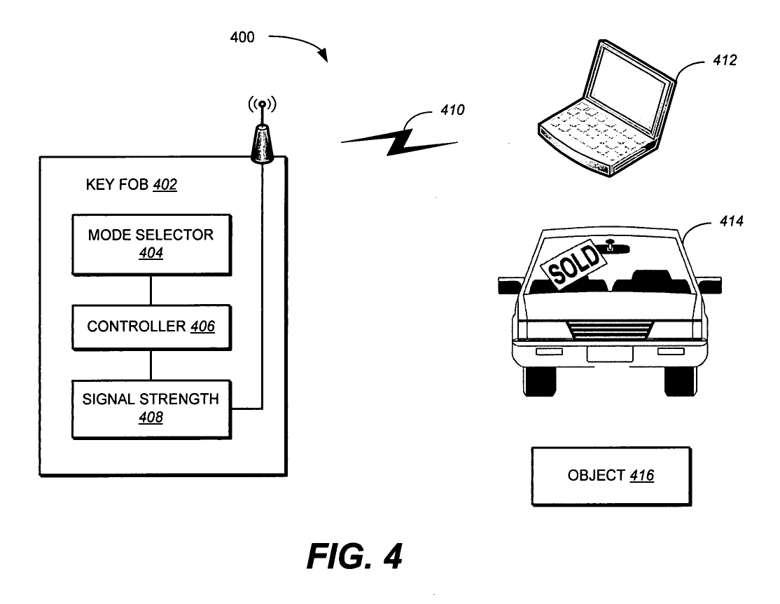

FIG. 4 illustrates a system 400 including a key fob 402 in accordance with one implementation. In one implementation, the key fob 402 includes a mode selector 404 and a controller 406 that controls a signal strength 408 of a signal 410 from the key fob 402. As shown in FIG. 4, the key fob 402 can wirelessly communicate with one or more of a laptop 412, an automobile 414, and/or an object 416. The object 416 can be any object, device, or system having a function that can be controlled by a key fob. In one implementation, the key fob 402 is operable to control a function associated with each of the laptop 412, the automobile 414, and the object 416. Or, for example, the key fob 402 can be used to control multiple objects of the same type—e.g., three different laptops. In another implementation, a separate key fob is required to communicate with each of the laptop 412, the automobile 414, and the object 416. In yet another implementation, multiple key fobs can be associated with a single device or object.

The mode selector 404 provides a user with the ability to select a mode of operation for the key fob. In one implementation, the mode selector 404 comprises a switch or a button. In another implementation, the mode selector 404 comprises a display screen that displays a menu of mode of operations selectable by the user. Thus, in operation, the controller 406 adjusts the signal strength 408 of the (communication) signal 410 in accordance with the mode of operation selected by the user. In one implementation, the signal strength 408 corresponding to each mode of operation is pre-determined based on application requirements.

The methods described above can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (“application-specific integrated circuits”).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

Various implementations for digital communications between a key fob and a host device have been described. Nevertheless, various modifications may be made to the implementations, and such modifications would be within the scope of the present invention. For example, methods discussed above can be performed in a different order to achieve desirable results. In addition, although FIG. 2 is described above with the key fob paging and the host device page-scanning, the roles of the two devices can be reversed—i.e., with the host device paging and the key fob page-scanning. Moreover, a key fob can be implemented such that each mode of operation (e.g., automatic/manual) are exclusive of one another, or the key fob can be implemented such that the modes of operation of the key fob are not exclusive of one another—e.g., a manual mode of operation is always available regardless of whether the key fob is operating in the automatic mode. The manual mode of operation generally includes controls to arm and disarm a host device; however, both functions do not have to be provided by the key fob. The difference in signal strengths can be dynamically set via location profiles set by (e.g.) a theft deterrent system as part of a security level definition (e.g., airport security setting vs. office setting may drive different preferences in signal level strengths). The techniques discussed above are applicable to other technologies including, for example, Ultra Wideband (UWB), 802.11a/b/g/n, Zigbee, IR, RFID, proprietary 2.4 Ghz protocols, or any other wireless technology (e.g., long range technology like WWAN or WiMax or any future developed technology). Accordingly, many modifications may be made by one of ordinary skill in the art without departing from the spirit and scope of the following claims.

What is claimed is:

1. A system comprising:
a key fob configured to operate in accordance with one of a plurality of modes, including an automatic mode and a manual mode; and
a host device associated with the key fob,
wherein responsive to the key fob operating in accordance with the automatic mode,
the key fob is configured to page periodically; and
the host device is configured to page-scan periodically to detect a page from the key fob.

2. The system of claim 1, wherein the key fob includes a mode selector configured to provide a user with an ability to select a mode of operation for the key fob.

3. The system of claim 2, wherein the mode selector comprises one or more of a switch, a button, or a display screen.

4. The system of claim 2, wherein the key fob further includes a controller configured to dynamically adjust a signal strength of a communication signal between the key fob and the host device in accordance with a mode of operation selected by the user.

5. The system of claim 4, wherein the controller is configured to increase the signal strength of the communication signal in response to the user selecting the manual mode of operation, and decrease the signal strength of the communication signal in response to the user selecting the automatic mode of operation.

6. The system of claim 5, wherein:
the plurality of modes of operation associated with the key fob are not exclusive of one another; and
the user is operable to select the manual mode of operation by pressing a manual button on the key fob at any time regardless of a current operation mode of the key fob.

7. The system of claim 1, wherein:
in response to the host device detecting a page from the key fob, the host device is operable to perform a first function; and
in response to the host device not detecting a page from the key fob, the host device is operable to perform a second function.

8. The system of claim 7, wherein:
the host device includes a theft deterrent system; and
the first function comprises disarming the theft deterrent system associated with the host device; and
the second function comprises arming the theft deterrent system associated with the host device.

9. The system of claim 1, wherein the host device comprises at least one of a workstation, a desktop computer, a laptop computer, a personal digital assistant (PDA), a cell phone, a network, a bicycle, an automobile, or other device having a function that is controllable by the key fob.

10. A system comprising:
a first device configured to operate in accordance with an automatic mode; and
a second device associated with the first device,
wherein responsive to the first device operating in accordance with the automatic mode,
the first device is configured to page periodically; and
the second device is configured to page-scan periodically to detect a page from the first device.

11. The system of claim 10, wherein:
the first device comprises a key fob; and
the second device comprises a host device.

12. The system of claim 11, wherein the key fob is further configured to operate in accordance with a manual mode, and includes a mode selector configured to provide a user with an ability to select a mode of operation for the key fob.

13. The system of claim 12, wherein the key fob further includes a controller configured to dynamically adjust a signal strength of a communication signal between the key fob and the host device in accordance with the mode of operation selected by the user.

14. The system of claim 13, wherein the controller is configured to increase the signal strength of the communication signal in response to the user selecting the manual mode of operation, and decrease the signal strength of the communication signal in response to the user selecting the automatic mode of operation.

15. The system of claim 11, wherein:
in response to the host device detecting a page from the key fob, the host device is operable to perform a first function; and
in response to the host device not detecting a page from the key fob, the host device is operable to perform a second function.

16. The system of claim 15, wherein:
the host device includes a theft deterrent system; and
the first function comprises disarming the theft deterrent system associated with the host device; and
the second function comprises arming the theft deterrent system associated with the host device.

17. A computer-implemented method comprising:
receiving user input selecting a mode of operation for a key fob; and
dynamically adjusting a signal strength of the key fob in accordance with the mode of operation selected by the user.

18. The method of claim 17, wherein:
the key fob configured to operate in accordance with an automatic mode and a manual mode; and
dynamically adjusting a signal strength of the key fob includes increasing the signal strength in response to the user selecting the manual mode, and decreasing the signal strength in response to the user selecting the automatic mode.

19. The method of claim 17, wherein receiving user input selecting a mode of operation comprises receiving user input though a display screen of the key fob.

20. The method of claim 17, wherein the key fob is a security key fob configured to arm and disarm a host device associated with the key fob.
